(19) United States
(12) Patent Application Publication
(10) Pub. No.: US 2024/0013490 A1
(43) Pub. Date: Jan. 11, 2024

(54) AUGMENTED LIVE CONTENT

(71) Applicant: Motorola Mobility LLC, Chicago, IL (US)

(72) Inventors: Chekit Mehta, Buffalo Grove, IL (US); Xiangyang Li, Haidian (CN)

(73) Assignee: Motorola Mobility LLC, Chicago, IL (US)

(21) Appl. No.: 17/879,170

(22) Filed: Aug. 2, 2022

(30) Foreign Application Priority Data
Jul. 5, 2022 (CN) 202210782783.8

(51) Int. Cl. G06T 19/00; H04N 21/2187

(52) U.S. Cl. CPC G06T 19/006; H04N 21/2187

(57) ABSTRACT

In aspects of augmented live content, a dual-camera device has a rear facing camera to capture scenic digital content of a camera scene, and also has a front facing camera to capture user digital content from a viewpoint opposite the rear facing camera. Imagers of the front and rear cameras are operational together to capture the scenic digital content and the user digital content approximately simultaneously. The dual-camera device implements an imaging manager that can identify an object depicted in the user digital content for extraction as an extracted object, identify at least one enhancement feature based on a geographic location of the dual-camera device, and then generate augmented live content by merging the extracted object with the scenic digital content and with the enhancement feature.

### RELATED APPLICATION

This application claims priority benefit of China Patent Application for Invention Serial No. 202210782783.8 filed Jul. 5, 2022 entitled “Augmented Live Content”, the disclosure of which is incorporated by reference herein in its entirety.

### BACKGROUND

Devices such as smart devices, mobile devices (e.g., cellular phones, tablet devices, smartphones), consumer electronics, and the like can be implemented for use in a wide range of environments and for a variety of different applications. Many different types of mobile phones and devices include dual cameras to capture digital images, with a front facing camera and a rear facing camera. Typically, only one of the dual cameras is active at any particular time and usable to capture digital images. Generally, the lens of the front facing camera is integrated in or around the display screen of a mobile device, and faces a user as he or she holds the device in a position to view the display screen. Users commonly use the front facing camera to take pictures (e.g., digital images) of themselves, such as self-portrait digital images often referred to as “selfies.” These dual-camera devices typically provide a selectable control, such as displayed on a user interface, that a user can select to switch between using the front facing camera or the rear facing camera. Generally, the lens of the rear facing camera is integrated in the back cover or housing of the device, and faces away from the user toward the surrounding environment, as seen from the point-of-view of the user. Users commonly use the rear facing camera to capture digital images and/or video of whatever they may see in front of them in the surrounding environment.

### BRIEF DESCRIPTION OF THE DRAWINGS

Implementations of the techniques for augmented live content are described with reference to the following Figures. The same numbers may be used throughout to reference like features and components shown in the Figures:

FIG. 1 illustrates an example of techniques for augmented live content in accordance with one or more implementations as described herein.

FIG. 2 illustrates an example device that can be used to implement techniques for augmented live content as described herein.

FIG. 3 illustrates examples of features for augmented live content in accordance with one or more implementations as described herein.

FIG. 4 illustrates an example method of augmented live content in accordance with one or more implementations of the techniques described herein.

FIG. 5 illustrates an example method of augmented live content in accordance with one or more implementations of the techniques described herein.

FIG. 6 illustrates various components of an example device that can used to implement the techniques for augmented live content as described herein.

### DETAILED DESCRIPTION

Implementations of augmented live content are described, and provide techniques implemented by a dual-camera device to merge an object extracted from user digital content captured with a front facing camera with scenic digital content captured as a digital photo or digital video content with a rear facing camera, and also merge one or more enhancement features to form augmented live content. The augmented live content (e.g., as a digital photo, a video clip, real-time video, live video stream, etc.) can then be displayed, recorded, and/or communicated to another device. For example, the augmented live content can be displayed on a display screen of the dual-camera device, which is then viewable by the user of the device. The augmented content of the extracted object merged with the scenic digital content and the enhancement feature may also be recorded, such as to memory of the device that maintains the recording for subsequent access. Additionally, the augmented live content may be communicated to another device. In implementations, the dual-camera device is a mobile phone or smartphone that can establish communication with other communication-enabled devices, and the mobile phone communicates the augmented live content, such as in the form of digital video content, for viewing at other devices that receive the augmented live content as a video chat or in another communication format of digital content.

In the described techniques, the scenic digital content can be captured as a digital photo or digital video content of the camera scene as viewable with the rear facing camera, such as a digital photo or a digital video of an environment as viewable with the rear facing camera. The user digital content is captured with the front facing camera from a viewpoint opposite of the rear facing camera, and the user digital content includes depictions of one or more objects, to include a self-image or a self-video of the user of the device. Notably, the rear facing camera and the front facing camera of the dual-camera device are operational together to capture the scenic digital content and the user digital content approximately simultaneously, and the user of the device does not have to switch between cameras or turn the device around to capture images or video of the surrounding environment. This provides that the user of the dual-camera device can both video chat with a person who has another device, and show the other person the environment that the user sees from the point-of-view of the user holding the dual-camera device. The person with the other device can then see both the user of the dual-camera device in a video chat format, and also see the surrounding environment from the user's perspective.

In aspects of augmented live content as described herein, the dual-camera device includes an imaging manager that is implemented to extract an object from one or more objects depicted in the user digital content captured with the front facing camera. The imaging manager can be implemented to utilize any type of selection criteria to determine which object to extract from the user digital content, such as based on face detection to select a self-image of the user, or based on object characteristics, such as the object that appears the largest of the objects in the digital image, or the object nearest the center of the digital image, or any other type of selection criteria. Alternatively or in addition, a user of the dual-camera device may provide a selection input, such as in a user interface displayed on the display screen of the device, and the imaging manager can receive the user selection input that identifies the selected object for extraction. The imaging manager can then extract the selected object from the digital image, such as user digital content that is captured as a self-image or self-video of the user with the front facing camera, and the extracted object from the user digital content is a depiction of the user.

In implementations of augmented live content as described herein, the imaging manager of the dual-camera device can utilize a location module to determine a geographic location of the dual-camera device. For example, the location module implemented with the imaging manager can determine an environment, such as the city, in which the dual-camera device is located, and further determine city information or other environment information of the geographic location of the dual-camera device. The imaging manager can utilize this city information to determine stored scenic content and/or one or more enhancement features to merge with the augmented live content. The stored scenic content can be any type of digital content, such as stock digital content, a still digital image, or a digital video depicting a landmark that is near the geographic location of the dual-camera device. The stored scenic content can also be implemented as any type of still or moving background, such as a solid color. The one or more enhancement features can also be any type of digital content, and can depict the city or environment information in any number of ways, such as depicting the weather conditions currently occurring in the city or environment, or depicting the date, time, and/or name of the city. Alternatively, or in addition to the imaging manager automatically determining stored scenic content and the enhancement features, the imaging manager may receive user input to select stock or additional scenic digital content and enhancement features.

The imaging manager implemented by the dual-camera device can then generate the combined image by merging the extracted object with the scenic digital content and with the one or more selected enhancement features. In implementations, the imaging manager can automatically size and position the extracted object to appear proportional to other objects depicted in the scenic digital content, and so as not to cover the other objects in the scenic digital content. Alternatively or in addition, the imaging manager can receive a user input to move or resize the depiction of the user as the extracted object that is merged with the scenic digital content and the one or more enhancement features. As noted above, the augmented live content (e.g., as a digital photo, a video clip, real-time video, live video stream, etc.) can then be displayed on a display screen of the dual-camera device, recorded to memory, and/or communicated to another device for viewing, such as in a video chat application.

While features and concepts of augmented live content can be implemented in any number of different devices, systems, environments, and/or configurations, implementations of augmented live content, as generated from merged digital content, are described in the context of the following example devices, systems, and methods.

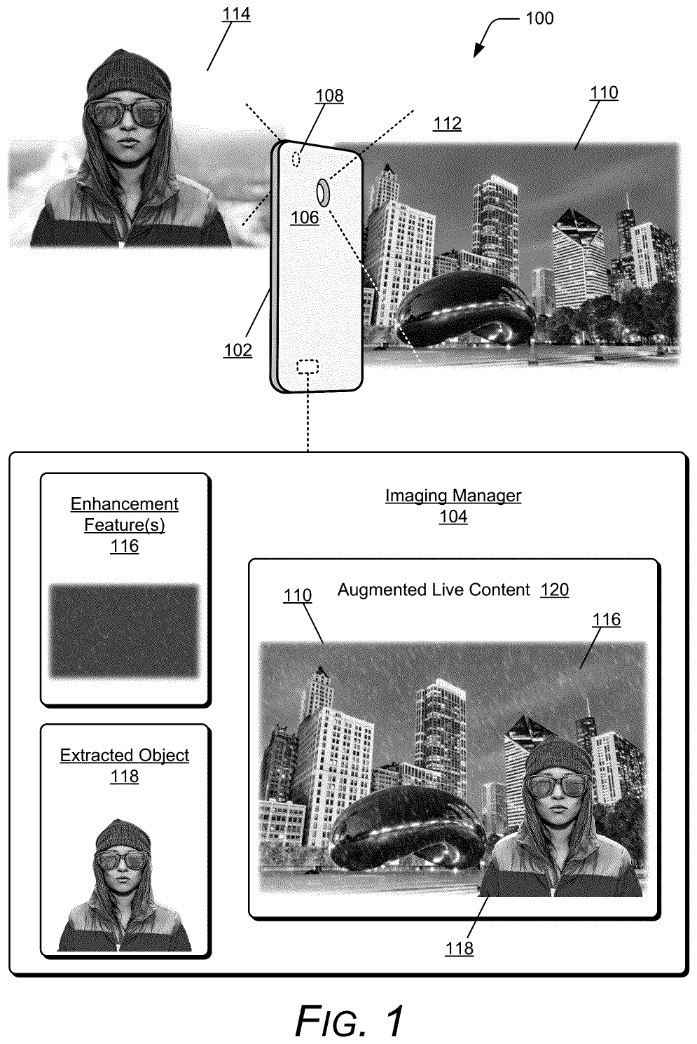

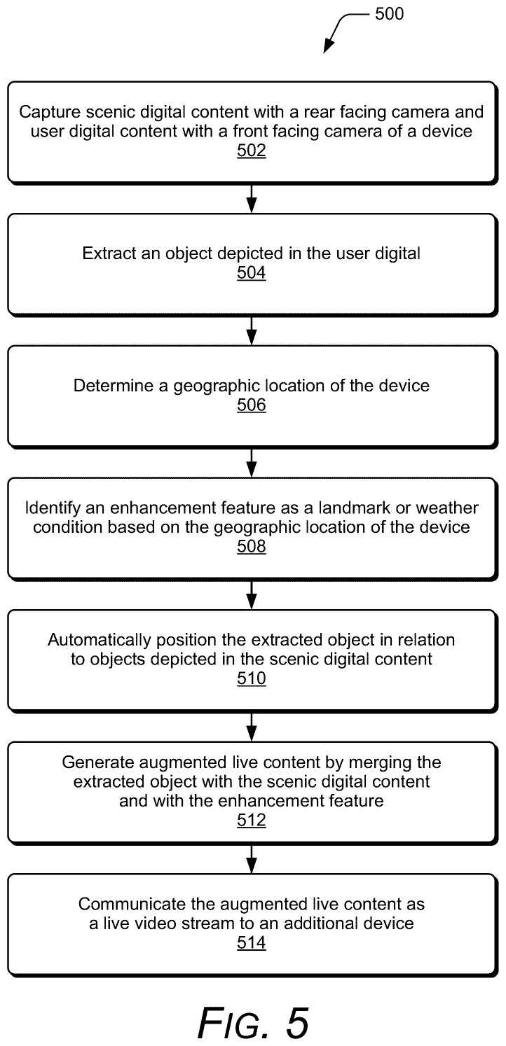

FIG. 1 illustrates an example 100 of techniques for augmented live content using a dual-camera device 102 that implements an imaging manager 104 to generate augmented live content, as described herein. In this example 100, the dual-camera device 102 may be any type of a mobile device, computing device, tablet device, mobile phone, flip phone, and/or any other type of device implemented with dual-cameras. Generally, the dual-camera device 102 may be any type of an electronic and/or computing device implemented with various components, such as a processor system and memory, as well as any number and combination of different components as further described with reference to the example device shown in FIG. 5.

In this example 100, the dual-camera device 102 has a rear facing camera 106 and a front facing camera 108. Generally, the rear facing camera 106 includes a lens that is integrated in the back cover or housing of the device, and faces away from a user of the device toward the surrounding environment. The rear facing camera 106 also has an imaging sensor, referred to as an imager, that receives light directed through the camera lens, which is then captured as scenic digital content 110, such as a digital photo, digital video, or live video stream content. For example, the scenic digital content 110 that is captured by the rear facing camera 106 may be a digital photo of an environment as viewable with the rear facing camera. The rear facing camera 106 has a field-of-view (FOV) of the camera, referred to herein as the camera scene 112. As used herein, the terms “digital content” and “scenic digital content” includes any type of digital image, digital photograph, a digital video frame of a video clip, digital video, live video stream, and/or any other type of digital content.

Similarly, the front facing camera 108 of the dual-camera device 102 includes a lens that is integrated in or around a display screen of the device, and the front facing camera 108 faces the user of the device as he or she holds the device in a position to view the display screen. The front facing camera 108 also has an imager that receives light directed through the camera lens, which is then captured as user digital content 114 from a viewpoint opposite the rear facing camera. Users commonly use the front facing camera 108 to take pictures or videos (e.g., digital images) of themselves, such as self-portrait digital images or self-portrait digital videos often referred to as “selfies.” For example, the user digital content 114 may be captured as a self-image with the front facing camera 108 from a viewpoint facing the user of the dual-camera device. Generally, the user digital content 114 may include depictions of one or more objects, to include an image or video of the user of the device and/or objects viewable within the field-of-view of the front facing camera 108.

In implementations of augmented live content as described herein, the imagers of the rear facing camera 106 and the front facing camera 108 are operational together to capture the scenic digital content 110 and the user digital content 114 approximately simultaneously. The dual-camera device 102 includes the imaging manager 104, which may be implemented as a module that includes independent processing, memory, and/or logic components functioning as a computing and/or electronic device integrated with the dual-camera device 102. Alternatively or in addition, the imaging manager 104 can be implemented as a software application or software module, such as integrated with an operating system as computer-executable software instructions that are executable with a processor of the dual-camera device 102. As a software application or module, the imaging manager 104 can be stored in memory of the device, or in any other suitable memory device or electronic data storage implemented with the imaging manager. As a software application or module, the imaging manager 104 may also be implemented as an artificial intelligence algorithm. Alternatively or in addition, the imaging manager 104 may be implemented in firmware and/or at least partially in computer hardware. For example, at least part of the imaging manager 104 may be executable by a computer processor, and/or at least part of the imaging manager may be implemented in logic circuitry.

In implementations of augmented live content as described herein, the scenic digital content 110 may be identified and/or obtained by the imaging manager 104, such as from stored scenic content, which may be an alternative or in addition to the scenic digital content captured by the rear facing camera 106. In implementations, the imaging manager 104 may include a location module to determine a geographic location of the dual-camera device 102, such as in a city or other environment. The geographic location may be determined by the imaging manager 104, or by a location module implemented with the imaging manager, using any number of location determination techniques. For example, the imaging manager 104 may utilize GPS technology to determine an environment, such as a city that the dual-camera device 102 is located in. The imaging manager 104 can then identify information about the city or environment in which the dual-camera device 102 is located. The imaging manager 104 can then determine and/or obtain stored scenic content associated with the environment or city using the environment or city information, which may depict a landmark in the city, or near the city.

The stored scenic content can be depicted in any form of digital content, such as a still image, a digital video, or a GIF. As shown in this example 100, the imaging manager 104 can determine that the dual-camera device 102 is located in the city of Chicago and depict the Cloud Gate sculpture as stored scenic content associated with the city or environment. Alternatively or in addition, the stored scenic content can be implemented as any type of still or moving background, such as a solid color. In implementations, the imaging manager 104 can automatically determine the stored scenic content, or the imaging manager can receive a user input as a selection of stored scenic content to merge with the extracted object 118, the one or more enhancement features 116, and/or the scenic digital content 110 to generate the augmented live content.

The imaging manager 104 can automatically identify and/or obtain one or more enhancement features 116 based on the geographic location of the dual-camera device 102. As described above, the imaging manager 104, or a location module implemented with the imaging manager, can determine a geographic location of the dual-camera device 102 and determine information about the environment or city in which the dual-camera device is located. The imaging manager 104 can depict this environment or city information as an enhancement feature 116 in any number of ways, such as depicting a weather condition of the city, or depicting the date, time, and/or name of the city. In this example 100, the imaging manager 104 determines that the dual-camera device 102 is located in the city of Chicago and determines that the current weather condition is snow. The imaging manager 104 can then determine and/or obtain the enhancement feature 116 to depict falling snow using a smart filter. The enhancement features 116 can be depicted using any type of digital content. Alternatively or in addition to the imaging manager 104 automatically determining the one or more enhancement features 116, the dual-camera device 102 can receive user input to select one or more enhancement features.

Additionally, the imaging manager 104 can identify and select an object from any of the objects that may be depicted in the user digital content 114 for extraction as an extracted object 118. In this example 100, the extracted object 118 from the user digital content 114 is a depiction of the user of the dual-camera device 102 who has captured the user digital content as a self-image with the front facing camera 108 from a viewpoint facing the user of the device. The imaging manager 104, which may be implemented as an artificial intelligence algorithm, can utilize any type of selection criteria to determine which object to select in the user digital content 114, such as the object that appears the largest of the objects in the user digital content, the object nearest the center of the user digital content, the object that has the greatest percentage of the field-of-view of the camera, the object that appears in a focus region of the user digital content, and/or using any other types of selection criteria, such as facial recognition techniques. Alternatively or in addition, a user of the dual-camera device 102 may provide a selection input, such as in a user interface displayed on the display screen of the device, and the imaging manager 104 can select the object for extraction from the user digital content based on receiving the user selection input that identifies the extracted object 118.

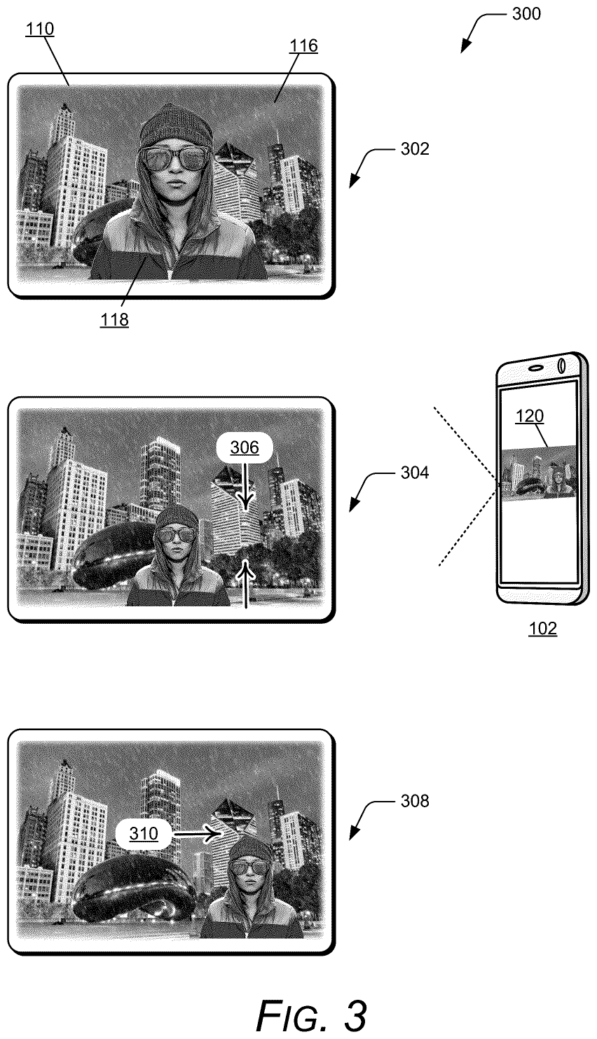

The imaging manager 104 can then generate the augmented live content 120, such as by merging the extracted object 118 with the scenic digital content 110 and with the one or more enhancement features 116. In this example 100, the augmented live content 120 is generated by the imaging manager 104 merging the depiction of the user with the scenic digital content 110 that depicts the city landmark, and with the enhancement feature 116 of the smart filter depicting falling snow. As described above, the scenic digital content 110 may be depicted as any type of digital content as captured by the rear facing camera 106 and/or as identified as stored scenic content by the imaging manager 104. The extracted object 118 may also be depicted as any type of digital content as captured by the front facing camera 108. The extracted object may be positioned and/or sized automatically by the imaging manager 104, or by way of user input as described in further detail in relation to FIG. 3.

Although referred to as live content, the augmented live content 120 may be a digital image, video clip, or a digital video that is generated in real-time with the extracted object 118 merged with the scenic digital content 110 and with the one or more enhancement features 116, which may then be communicated as a video chat or in another communication format to another device. In aspects of augmented live content as described herein, the augmented live content 120 may be displayed, recorded, and/or communicated to another device. For example, the augmented live content 120 (e.g., as a digital photo, a video clip, real-time video, live video stream, etc.) can be displayed on a display screen of the dual-camera device 102, which is then viewable by the user of the device as the extracted object 118 merged with the scenic digital content 110 and with the one or more enhancement features 116. The augmented live content 120 may also be recorded, such as to memory of the device that maintains the recording for subsequent access, or communicated for cloud-based storage. In implementations, the dual-camera device 102 is a mobile phone or smartphone that can establish communication with other communication-enabled devices, and the mobile phone communicates the augmented live content 120 for viewing at other devices that receive the augmented live content as a video chat or in another communication format of digital content.

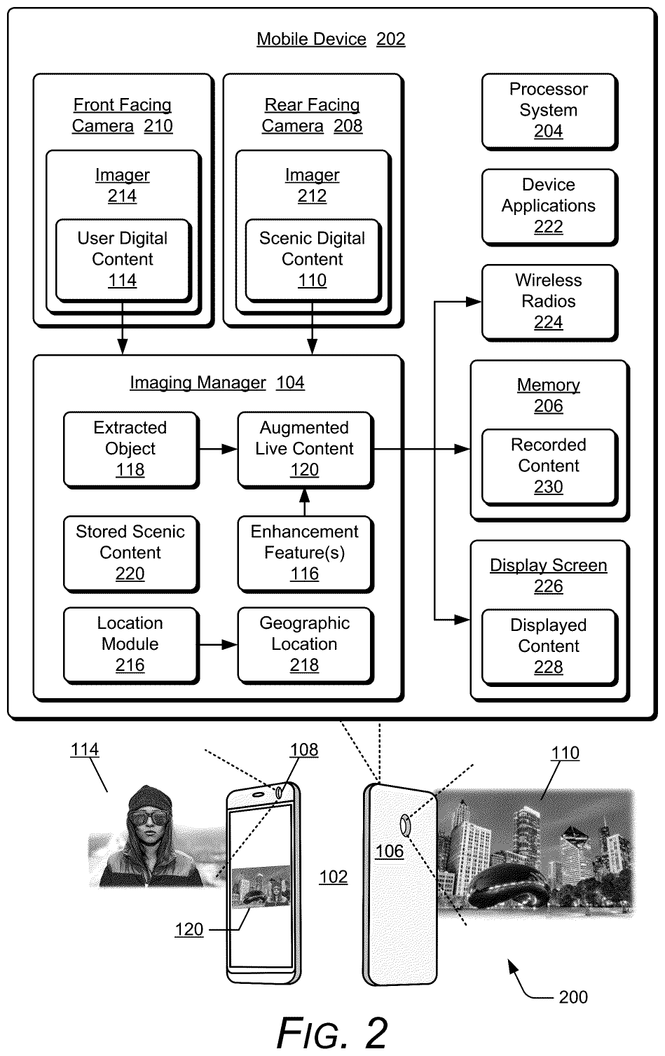

FIG. 2 illustrates an example 200 of a mobile device 202 that can be used to implement the techniques of augmented live content, as described herein, such as the dual-camera device 102 that is shown and described with reference to FIG. 1. In this example 200, the mobile device 202 may be any type of a computing device, tablet device, mobile phone, flip phone, and/or any other type of mobile device. Generally, the mobile device 202 may be any type of an electronic and/or computing device implemented with various components, such as a processor system 204, to include an integrated or independent video graphics processor, and memory 206, as well as any number and combination of different components as further described with reference to the example device shown in FIG. 5. For example, the mobile device 202 can include a power source to power the device, such as a rechargeable battery and/or any other type of active or passive power source that may be implemented in an electronic and/or computing device.

In implementations, the mobile device 202 may be a mobile phone (also commonly referred to as a “smartphone”) implemented as a dual-camera device. The mobile device 202 includes a rear facing camera 208 and a front facing camera 210. Although the devices are generally described herein as dual-camera devices having two cameras, any one or more of the devices may include more than two cameras. For example, an implementation of the rear facing camera 208 may include two or three individual cameras itself, such as to capture digital content at different focal lengths and/or at different apertures approximately simultaneously.

In this example 200, the rear facing camera 208 of the mobile device 202 includes an imager 212 to capture the scenic digital content 110, such as a digital photo or digital video content. For example, the scenic digital content 110 that is captured by the rear facing camera 208 may be a digital photo of an environment as viewable with the rear facing camera (also referred to herein as the camera scene). As shown and described with reference to FIG. 1, the scenic digital content 110 that is captured with the rear facing camera 106 of the dual-camera device 102 is an example of the scenic digital content 110 that may be captured by the rear facing camera 208 of the mobile device 202.

Similarly, the front facing camera 210 of the mobile device 202 includes an imager 214 to capture the user digital content 114 from a viewpoint opposite the rear facing camera. Generally, the user digital content 114 may include depictions of one or more objects, to include an image of a user of the device and/or objects viewable within the field-of-view of the front facing camera. As shown and described with reference to FIG. 1, the user digital content 114 that is captured with the front facing camera 108 of the dual-camera device 102 as a self-image and/or self-video from the viewpoint of the user holding the device and facing the camera is an example of the user digital content 114 that may be captured by the front facing camera 210 of the mobile device 202. As noted above and in the described implementations of augmented live content, the imager 212 of the rear facing camera 208 and the imager 214 of the front facing camera 210 are operational together to capture the scenic digital content 110 and the user digital content 114 approximately simultaneously.

In this example 200, the mobile device 202 includes the imaging manager 104 that implements features of augmented live content, as described herein and generally as shown and described with reference to FIG. 1. The imaging manager 104 may be implemented as a module that includes independent processing, memory, and/or logic components functioning as a computing and/or electronic device integrated with the mobile device 202. Alternatively or in addition, the imaging manager 104 can be implemented as a software application or software module, such as integrated with an operating system and as computer-executable software instructions that are executable with a processor (e.g., with the processor system 204) of the mobile device 202. As a software application or module, the imaging manager 104 can be stored on computer-readable storage memory (e.g., the memory 206 of the device), or in any other suitable memory device or electronic data storage implemented with the imaging manager. As a software application or module, the imaging manager 104 may also be implemented as an artificial intelligence algorithm. Alternatively or in addition, the imaging manager 104 may be implemented in firmware and/or at least partially in computer hardware. For example, at least part of the imaging manager 104 may be executable by a computer processor, and/or at least part of the imaging manager may be implemented in logic circuitry.

Additionally, the imaging manager 104 may include, implement, or interface with a location module 216 that is included to determine the geographic location 218 of the mobile device 202, from which the imaging manager 104 can determine stored scenic content 220 related to the geographic location, and determine the enhancement features 116 that are used to generate the augmented live content 120. In implementations, the location module 216 may be implemented as a software component or module of the imaging manager 104 (as shown), or alternatively, as an independent device application 222 that interfaces with the imaging manager 104 and/or an operating system of the device. Generally, the mobile device 202 includes the device applications 222, such as any type of user and/or device applications that are executable on the device. For example, the device applications 222 can include a video chat application that a user of the mobile device 202 may initiate to communicate via video chat with a user of another device in communication with the mobile device.

In implementations, the mobile device 202 can communicate with other devices via a network (e.g., LTE, WLAN, etc.) or via a direct peer-to-peer connection (e.g., Wi-Fi Direct, Bluetooth™, Bluetooth LE (BLE), RFID, NFC, etc.). The mobile device 202 can include wireless radios 224 that facilitate wireless communications, as well as communication interfaces that facilitate network communications. The mobile device 202 can be implemented for data communication between devices and network systems, which may include wired and/or wireless networks implemented using any type of network topology and/or communication protocol, to include IP based networks, and/or the Internet, as well as networks that are managed by mobile network operators, such as a communication service provider, mobile phone providers, and/or Internet service providers.

In implementations of augmented live content as described herein, the scenic digital content 110 may be identified by the imaging manager 104 as stored scenic content 220 (e.g., as an alternative or in addition to the scenic digital content 110 being captured by the rear facing camera 208). The stored scenic content 220 may be stock digital images or any other types of digital content that may be stored on the device, such as in memory 206, or stored on a cloud-based site and obtained by the mobile device from the cloud-based storage.

The location module 216 can determine the geographic location 218 of the mobile device 202, which may be determined using any number of location determination techniques, such as utilizing GPS technology to determine an environment or a city that the mobile device 202 is located in. The imaging manager 104 can then identify information about the environment or the city in which the mobile device 202 is located. Additionally, the stored scenic content 220 can be determined and/or obtained by the imaging manager 104 using the environment and/or city information, such as to depict a landmark in the city, or near the city. Alternatively or in addition, the stored scenic content 220 may include a still or moving background, such as a solid color. The stored scenic content can be depicted in any form of digital content, such as a still image, a digital video, or a GIF. The scenic content depicting the Cloud Gate sculpture as shown and described with reference to FIG. 1 is an example of the stored scenic content 220 determined by the imaging manager 104.

The imaging manager 104 can also automatically identify and/or obtain one or more of the enhancement features 116 based on the geographic location 218 of the mobile device 202. As described above, the location module 216 can determine the geographic location of the mobile device 202 and determine information about the environment or city in which the mobile device is located. The imaging manager 104 can depict this environment or city information as an enhancement feature in any number of ways, such as depicting a weather condition currently occurring in the city, or depicting the date, time, and/or the name of the city. As shown in FIG. 1, the enhancement feature 116 may be depicted as falling snow to reflect the actual weather conditions of the city in which the dual-camera device 102 is located. This is an example of how the imaging manager 104 can automatically determine enhancement features. Alternatively or in addition to the imaging manager 104 automatically determining the enhancement features, the mobile device 202 can receive a user input as a selection of one or more of the enhancement features.

In implementations of augmented live content, the imaging manager 104 can select an object from any of the objects that may be depicted in the user digital content 114 for extraction from the user digital content. For example, the selected object may be selected by the imaging manager 104 as a depiction of the user of the mobile device 202. The imaging manager 104, which may be implemented as an artificial intelligence algorithm, may utilize any type of selection criteria to determine which object to select from the user digital content 114, such as the object that appears the largest of the objects in the digital image, the object nearest the center of the digital image, the object that has the greatest percentage of the field-of-view of the camera, the object that appears in a focus region of the captured digital image, and/or by use of any other type of selection criteria, such as facial recognition techniques. Alternatively, a user of the mobile device 202 may provide a selection input, such as in a user interface displayed on a display screen 226 of the device, and the imaging manager 104 can select the object for extraction from the user digital content based on receiving the user selection input that identifies the object to be extracted.

The imaging manager 104 is implemented to extract the object from the user digital content 114 as the extracted object 118. As shown in FIG. 1, the extracted object 118 from the user digital content 114 is a depiction of the user of the dual-camera device 102 who has captured a self-image or self-video. The imaging manager 104 can then generate the augmented live content 120, such as by merging the extracted object 118 with the scenic digital content 110 and at least one of the enhancement features 116. The scenic digital content 110 may either be captured by the rear facing camera 208, or determined and obtained from the stored scenic content 220, such as a stock digital image or content. In the example 100 shown and described with reference to FIG. 1, the augmented live content 120 is generated by the imaging manager 104 merging the depiction of the user (e.g., the extracted object 118) from the user digital content with a digital photo or video of the environment (e.g., the scenic digital content 110) and with the enhancement feature 116 that depicts the falling snow. In implementations, the extracted object 118 can be automatically positioned and/or sized in proportion to other objects depicted in the scenic digital content, such as further described in relation to FIG. 3.

Although referred to as live content, the augmented live content 120 may be a digital image, a video clip, or a digital video that is generated in real-time with the extracted object 118, along with one or more of the enhancement features 116. The augmented live content 120 can then be communicated as a video chat or in another communication format to another device. Additionally, the augmented live content 120 may be communicated to another device as a video chat in real-time, or as recorded digital content in another communication format.

In implementations, the augmented live content 120 may also be displayed and/or recorded. For example, the augmented live content (e.g., as a digital photo, a video clip, real-time video, live video stream, etc.) can be rendered for viewing as the displayed content 228 on the display screen 226 of the mobile device 202, which is then viewable by the user of the device as the extracted object 118 merged with the scenic digital content 110 and with enhancement features 116 as identified, determined, and/or obtained by the imaging manager 104. In another example, the augmented live content 120 generated from the depiction of the user in the user digital content 114 merged with the digital photo or digital video of the environment (e.g., the scenic digital content 110) is shown as displayed content on the display screen of the dual-camera device 102. The augmented live content 120 may also be recorded, such as to the memory 206 of the mobile device 202 that maintains the recorded content 230 (e.g., recorded digital content) for subsequent access, and/or for communication for cloud-based storage.

FIG. 3 illustrates examples 300 of features of techniques for augmented live content, as described herein. As noted above, the augmented live content 120 that is generated by the imaging manager 104 as the depiction of the user (e.g., the extracted object 118) from the user digital content 114 merged with the scenic digital content 110 and with an enhancement feature 116 is shown as displayed content on the display screen of the dual-camera device 102. In implementations, the imaging manager 104 can automatically size and position the extracted object 118 that is merged with the scenic digital content 110 and the enhancement feature 116. Alternatively or in addition, a user may interact with the display of the augmented live content 120 via the user interface on the display screen of the device to size and position the extracted object 118 that is merged with the scenic digital content 110 and the enhancement feature 116. For example, as shown at 302, the imaging manager 104 can generate the augmented live content 120 by merging the extracted object 118 with the scenic digital content 110 and the enhancement feature 116. At 302, the extracted object 118 has not been sized or positioned in relation to the scenic digital content 110.

Further, as shown at 304, the extracted object 118 is sized down 306 such that the extracted object 118 is approximately a proportional size relative to objects in the scenic digital content 110, such as the Cloud Gate sculpture shown in the scenic digital content. Notably, the extracted object 118 can be sized up or sized down according to the imaging manager 104. Similarly, the imaging manager 104 can receive user input to increase or decrease the size of the extracted object (e.g., an expand or a pinch gesture). As further shown at 308, the extracted object 118 is positioned by the imaging manager so as to not block a depicted object depicted in the scenic digital content 110 (e.g., the Cloud Gate sculpture in the environment). The extracted object 118 is moved to the right 310 such that the depicted object is not blocked by the extracted object 118. Notably, the extracted object 118 can be moved right, left, up, and/or down in relation to objects depicted in the scenic digital content 110, as determined by the imaging manager 104. Similarly, the imaging manager 104 can receive user input to position the extracted object 118, moving the extracted object left, right, up, and/or down.

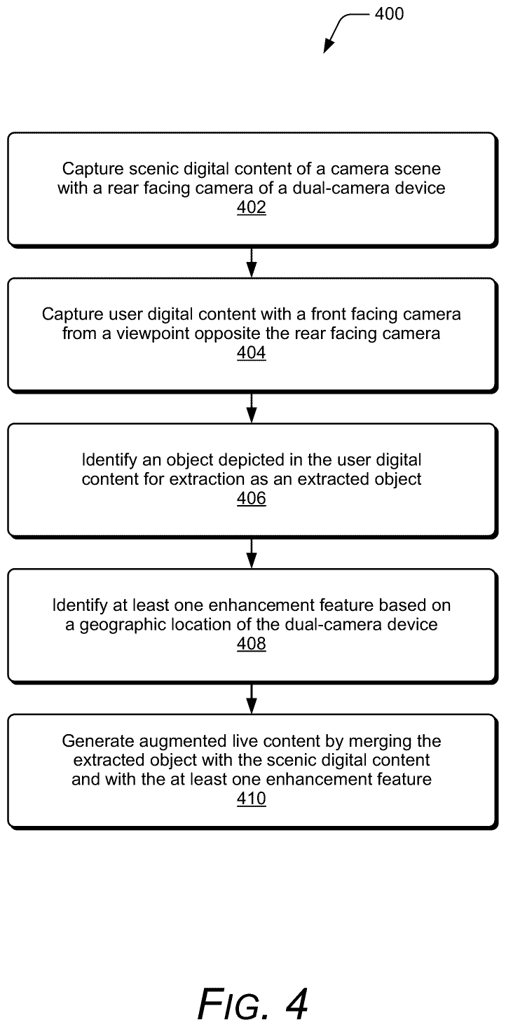

Example methods 400 and 500 are described with reference to respective FIGS. 4 and 5 in accordance with implementations of augmented live content. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates example method(s) 400 of augmented live content, and is generally described with reference to a dual-camera device and an imaging manager implemented by the device. The order in which the method is described is not intended to be construed as a limitation, and any number or combination of the described method operations can be performed in any order to perform a method, or an alternate method.

At 402, scenic digital content of a camera scene is captured with a rear facing camera of a dual-camera device. For example, the rear facing camera 106 of the dual-camera device 102 captures the scenic digital content 110 of the camera scene 112. The scenic digital content 110 can be any type of depiction of an environment as a digital image, digital video, etc. as viewable with the rear facing camera.

At 404, user digital content is captured with a front facing camera from a viewpoint opposite the rear facing camera. For example, the front facing camera 108 of the dual-camera device 102 captures the user digital content 114 that includes depictions of one or more objects. The user digital content 114 may be captured as a self-image or self-video with the front facing camera 108 from a viewpoint facing a user of the dual-camera device. For example, the front facing camera 108 faces the user of the device as he or she holds the device in a position to view the display screen, and the user can capture a self-image or a self-video (e.g., a self-portrait digital image or a self-portrait digital video). Notably, the rear facing camera 106 and the front facing camera 108 of the dual-camera device 102 are operational together to capture the scenic digital content 110 and the user digital content 114 approximately simultaneously.

At 406, an object depicted in the user digital content is identified for extraction as an extracted object. For example, the imaging manager 104 implemented by the dual-camera device 102 selects an object depicted in the user digital content 114 for extraction as the extracted object 118. The imaging manager 104 may utilize any type of selection criteria to determine which object to select in a digital image for extraction, such as the object that appears the largest of the objects in the digital image, the object nearest the center of the digital image, the object that has the greatest percentage of the field-of-view of the camera, the object that appears in a focus region of the captured digital image, and/or any other types of selection criteria, such as facial recognition techniques. Alternatively or in addition, a user of the dual-camera device 102 may provide a selection input, such as in a user interface displayed on the display screen of the device, and the imaging manager 104 extracts the object from the user digital content 114 based on receiving the user selection input.

At 408, at least one enhancement feature is identified based on a geographic location of the dual-camera device. For example, the imaging manager 104 is implemented with the location module 216 that determines a geographic location 218 of the dual-camera device 102, and the imaging manager 104 determines information about the environment or city in which the dual-camera device is located. The imaging manager 104 can depict environment or city information as an enhancement feature 116 in any number of ways, such as depicting a weather condition of the city, or depicting the date, time, and/or name of the city. The enhancement features 116 can be depicted using any type of digital content. Alternatively or in addition to the imaging manager 104 automatically determining the one or more enhancement features 116, the dual-camera device 102 can receive user input to select one or more of the enhancement features.

At 410, augmented live content is generated by merging the extracted object with the scenic digital content and with the at least one enhancement feature. For example, the imaging manager 104 merges the extracted object 118 with the scenic digital content 110 and with the one or more of the enhancement features 116 to generate the augmented live content 120. The scenic digital content 110 may be captured by the rear facing camera 106, or identified by the imaging manager 104 as a nearby landmark based on the geographic location of the dual-camera device 102. The scenic digital content 110 may also be in any form of digital content, such as a still digital image, a digital video, or a GIF. As noted above at 408, the enhancement features 116 may depict environment or city information in any number of ways, such as depicting the current weather condition of the city in which the dual-camera device 102 is located.

FIG. 5 illustrates example method(s) 500 of augmented live content, and is generally described with reference to a dual-camera device and an imaging manager implemented by the device. The order in which the method is described is not intended to be construed as a limitation, and any number or combination of the described method operations can be performed in any order to perform a method, or an alternate method.

At 502, scenic digital content is captured with a rear facing camera and user digital content is captured with a front facing camera of a device. For example, the rear facing camera 106 of the dual-camera device 102 captures the scenic digital content 110 of the camera scene 112, and the front facing camera 108 of the dual-camera device 102 captures the user digital content 114.

At 504, an object depicted in the user digital content is extracted. For example, the imaging manager 104 implemented by the dual-camera device 102 extracts an object depicted in the user digital content 114 as the extracted object 118. At 506, a geographic location of the device is determined. For example, the imaging manager 104 is implemented with the location module 216 that determines the geographic location 218 of the dual-camera device 102.

At 508, an enhancement feature is identified as a landmark or weather condition based on the geographic location of the device. For example, the imaging manager 104 identifies an enhancement feature 116, such as a city or environment landmark, or a current weather condition at the geographic location of the dual-camera device 102. At 510, the extracted object is automatically positioned in relation to objects depicted in the scenic digital content. For example, the imaging manager 104, which can be implemented as an artificial intelligence algorithm, positions and/or sizes the extracted object 118 to a visual perspective, as well as to a size and position that are proportional to other objects depicted the digital scenic content.

At 512, augmented live content is generated by merging the extracted object with the scenic digital content and with the enhancement feature. For example, the imaging manager 104 merges the extracted object 118 with the scenic digital content 110 and with the enhancement feature 116 to generate the augmented live content 120. At 514, the augmented live content is communicated as a live video stream to an additional device. For example, the dual-camera device 102 communicates the augmented live content 120 to an additional device. In implementations, the dual-camera device 102 is a mobile phone that can establish communication with other communication-enabled devices, and the mobile phone communicates the augmented live content 120 for viewing at other devices.

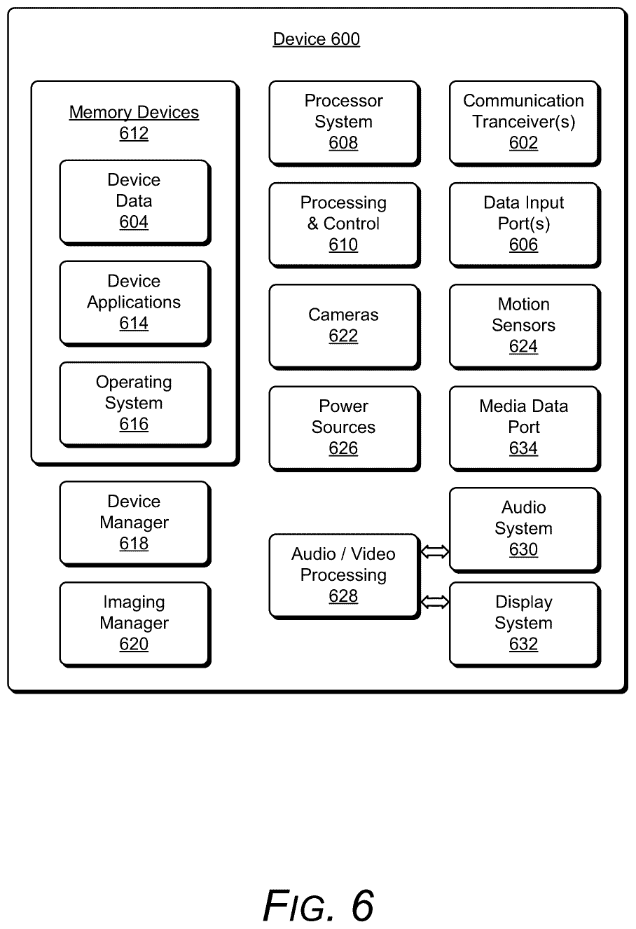

FIG. 6 illustrates various components of an example device 600, in which aspects of augmented live content can be implemented. The example device 600 can be implemented as any of the devices described with reference to the previous FIGS. 1-5, such as any type of a mobile device, mobile phone, flip phone, client device, companion device, paired device, display device, tablet, computing, communication, entertainment, gaming, media playback, and/or any other type of computing and/or electronic device. For example, the dual-camera device 102 and the mobile device 202 described with reference to FIGS. 1 and 2 may be implemented as the example device 600.

The device 600 includes communication transceivers 602 that enable wired and/or wireless communication of device data 604 with other devices. The device data 604 can include any of the various devices and imaging manager generated, determined, received, and/or stored data. Additionally, the device data 604 can include any type of audio, video, and/or image data. Example communication transceivers 602 include wireless personal area network (WPAN) radios compliant with various IEEE 802.15 (Bluetoot™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 600 may also include one or more data input ports 606 via which any type of data, media content, and/or inputs can be received, such as user-selectable inputs to the device, communications, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 600 includes a processor system 608 of one or more processors (e.g., any of microprocessors, controllers, and the like) and/or a processor and memory system implemented as a system-on-chip (SoC) that processes computer-executable instructions. The processor system may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 610. The device 600 may further include any type of a system bus or other data and command transfer system that couples the various components within the device. A system bus can include any one or combination of different bus structures and architectures, as well as control and data lines.

The device 600 also includes memory and/or memory devices 612 (e.g., computer-readable storage memory) that enable data storage, such as data storage devices that can be accessed by a computing device, and that provide persistent storage of data and executable instructions (e.g., software applications, programs, functions, and the like). Examples of the memory devices 612 include volatile memory and non-volatile memory, fixed and removable media devices, and any suitable memory device or electronic data storage that maintains data for computing device access. The memory devices 612 can include various implementations of random access memory (RAM), read-only memory (ROM), flash memory, and other types of storage media in various memory device configurations. The device 600 may also include a mass storage media device.

The memory devices 612 (e.g., as computer-readable storage memory) provides data storage mechanisms to store the device data 604, other types of information and/or data, and various device applications 614 (e.g., software applications and/or modules). For example, an operating system 616 can be maintained as software instructions with a memory device and executed by the processor system 608. The device applications 614 may also include a device manager 618, such as any form of a control application, software application, signal-processing and control module, code that is specific to a particular device, a hardware abstraction layer for a particular device, and so on.

In this example, the device 600 includes an imaging manager 620 that implements aspects of augmented live content. The imaging manager 620 may be implemented with hardware components and/or in software as one of the device applications 614, such as when the device 600 is implemented as the dual-camera device 102 described with reference to FIG. 1, or as the mobile device 202 described with reference to FIG. 2. Examples of the imaging manager 620 includes the imaging manager 104 that is implemented by the dual-camera device 102, and as described implemented by the mobile device 202, such as a software application and/or as hardware components in the dual-camera device and/or in the mobile device. In implementations, the imaging manager 620 may include independent processing, memory, and logic components as a computing and/or electronic device integrated with the example device 600.

In this example, the device 600 also includes cameras 622 and motion sensors 624, such as may be implemented as components of an inertial measurement unit (IMU). The motion sensors 624 can be implemented with various sensors, such as a gyroscope, an accelerometer, and/or other types of motion sensors to sense motion of the device. The motion sensors 624 can generate sensor data vectors having three-dimensional parameters (e.g., rotational vectors in x, y, and z-axis coordinates) indicating location, position, acceleration, rotational speed, and/or orientation of the device. The device 600 can also include one or more power sources 626, such as when the device is implemented as a mobile device. The power sources may include a charging and/or power system, and can be implemented as a flexible strip battery, a rechargeable battery, a charged super-capacitor, and/or any other type of active or passive power source.

The device 600 can also include an audio and/or video processing system 628 that generates audio data for an audio system 630 and/or generates display data for a display system 632. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as via media data port 634. In implementations, the audio system and/or the display system are integrated components of the example device. Alternatively, the audio system and/or the display system are external, peripheral components to the example device.

Although implementations of augmented live content have been described in language specific to features and/or methods, the subject of the appended claims is not necessarily limited to the specific features or methods described. Rather, the specific features and methods are disclosed as example implementations of augmented live content, and other equivalent features and methods are intended to be within the scope of the appended claims. Further, various different examples are described and it is to be appreciated that a described example can be implemented independently or in connection with one or more other described examples. Additional aspects of the techniques, features, and/or methods discussed herein relate to one or more of the following:

A dual-camera device, comprising: a rear facing camera with a first imager to capture scenic digital content of a camera scene; a front facing camera with a second imager to capture user digital content from a viewpoint opposite the rear facing camera, the first and second imagers operational together to capture the scenic digital content and the user digital content approximately simultaneously; an imaging manager implemented at least partially in computer hardware to: identify an object depicted in the user digital content for extraction as an extracted object; identify at least one enhancement feature based at least in part on a geographic location of the dual-camera device; and generate augmented live content by merging the extracted object with the scenic digital content and with the at least one enhancement feature.

Alternatively or in addition to the above-described dual-camera device, any one or combination of: a location module implemented at least partially in the computer hardware to determine the geographic location of the dual-camera device. The imaging manager is implemented to initiate communication of the augmented live content of the extracted object merged with the scenic digital content and with the at least one enhancement feature to an additional device. The augmented live content is communicated to the additional device as a live video stream of the extracted object and the scenic digital content merged with the at least one enhancement feature. The imaging manager is implemented to determine stored scenic content as at least one of a still image, digital video, or a GIF usable with the augmented live content. The stored scenic content depicts a landmark near the geographic location of the dual-camera device. The imaging manager automatically positions the extracted object in relation to objects depicted in the scenic digital content. The at least one enhancement feature includes a visual effect depicting weather currently occurring in the geographic location of the dual-camera device. The at least one enhancement feature includes a visual effect that portrays information about the geographic location of the dual-camera device. The extracted object of the user digital content and the scenic digital content is one of a still image or a digital video. The user digital content depicts a user of the dual-camera device as captured by the front-facing camera and the extracted object is a cutout of the user depicted in the user digital content.

A method, comprising: capturing scenic digital content of a camera scene with a rear facing camera of a dual-camera device; capturing user digital content with a front facing camera from a viewpoint opposite the rear facing camera, the rear facing camera and the front facing camera being operational together to capture the scenic digital content and the user digital content approximately simultaneously; identifying an object depicted in the user digital content for extraction as an extracted object; identifying at least one enhancement feature based at least in part on a geographic location of the dual-camera device; and generating augmented live content by merging the extracted object with the scenic digital content and with the at least one enhancement feature.

Alternatively or in addition to the above-described method, any one or combination of: communicating the augmented live content as a live video stream of the extracted object merged with the scenic digital content and with the at least one enhancement feature to an additional device. The method further comprising merging a depiction of a landmark that is near the geographic location of the dual-camera device with the augmented live content, the depiction of the landmark including at least one of a still image, digital video, or a GIF. The method further comprising determining a weather condition in the geographic location of the dual-camera device; and depicting the weather condition as the at least one enhancement feature in the augmented live content. The method further comprising automatically positioning the extracted object in relation to objects depicted in the scenic digital content.

A device, comprising: a location module implemented at least partially in computer hardware to determine a geographic location of the device; an imaging manager implemented at least partially in the computer hardware to: identify an object depicted in user digital content for extraction as an extracted object; identify at least one enhancement feature based at least in part on a geographic location of the device; and generate augmented live content by merging the extracted object with scenic digital content and with the at least one enhancement feature.

Alternatively or in addition to the above described device, any one or combination of: multiple imagers operational together to capture the scenic digital content with a rear facing camera, and capture the user digital content with a front facing camera, the user digital content including the object for extraction. The imaging manager is implemented as an artificial intelligence algorithm to generate the augmented live content from the extracted object, the scenic digital content, and the at least one enhancement feature. The imaging manager is implemented to determine stored scenic content as at least one of a still image, digital video, or a GIF usable with the augmented live content.

1. A dual-camera device, comprising:
a rear facing camera with a first imager to capture scenic digital content of a camera scene;
a front facing camera with a second imager to capture user digital content from a viewpoint opposite the rear facing camera, the first imager and second imager operational together to capture the scenic digital content and the user digital content approximately simultaneously; and
an imaging manager implemented at least partially in computer hardware to:
identify an object depicted in the user digital content for extraction as an extracted object;
identify at least one enhancement feature based at least in part on a geographic location of the dual-camera device; and
generate augmented live content by merging the extracted object with the scenic digital content and with the at least one enhancement feature.

2. The dual-camera device of claim 1, further comprising a location module implemented at least partially in the computer hardware to determine the geographic location of the dual-camera device.

3. The dual-camera device of claim 1, wherein the imaging manager is implemented to initiate communication of the augmented live content of the extracted object merged with the scenic digital content and with the at least one enhancement feature to an additional device.

4. The dual-camera device of claim 3, wherein the augmented live content is communicated to the additional device as a live video stream of the extracted object and the scenic digital content merged with the at least one enhancement feature.

5. The dual-camera device of claim 1, wherein the imaging manager is implemented to determine stored scenic content as at least one of a still image, digital video, or a GIF usable with the augmented live content.

6. The dual-camera device of claim 5, wherein the stored scenic content depicts a landmark near the geographic location of the dual-camera device.

7. The dual-camera device of claim 1, wherein the imaging manager automatically positions the extracted object in relation to objects depicted in the scenic digital content.

8. The dual-camera device of claim 1, wherein the at least one enhancement feature includes a visual effect depicting weather currently occurring in the geographic location of the dual-camera device.

9. The dual-camera device of claim 1, wherein the at least one enhancement feature includes a visual effect that portrays information about the geographic location of the dual-camera device.

10. The dual-camera device of claim 1, wherein the extracted object of the user digital content and the scenic digital content is one of a still image or a digital video.

11. The dual-camera device of claim 1, wherein the user digital content depicts a user of the dual-camera device as captured by the front facing camera and the extracted object is a cutout of the user depicted in the user digital content.

12. A method, comprising:
capturing scenic digital content of a camera scene with a rear facing camera of a dual-camera device;
capturing user digital content with a front facing camera from a viewpoint opposite the rear facing camera, the rear facing camera and the front facing camera being operational together to capture the scenic digital content and the user digital content approximately simultaneously;
identifying an object depicted in the user digital content for extraction as an extracted object;
identifying at least one enhancement feature based at least in part on a geographic location of the dual-camera device; and
generating augmented live content by merging the extracted object with the scenic digital content and with the at least one enhancement feature.

13. The method of claim 12, further comprising:
communicating the augmented live content as a live video stream of the extracted object merged with the scenic digital content and with the at least one enhancement feature to an additional device.

14. The method of claim 12, further comprising:
merging a depiction of a landmark that is near the geographic location of the dual-camera device with the augmented live content, the depiction of the landmark including at least one of a still image, digital video, or a GIF.

15. The method of claim 12, further comprising:
determining a weather condition in the geographic location of the dual-camera device; and
depicting the weather condition as the at least one enhancement feature in the augmented live content.

16. The method of claim 12, further comprising:
automatically positioning the extracted object in relation to objects depicted in the scenic digital content.

17. A device, comprising:
a location module implemented at least partially in computer hardware to determine a geographic location of the device; and
an imaging manager implemented at least partially in the computer hardware to:
identify an object depicted in user digital content for extraction as an extracted object;
identify at least one enhancement feature based at least in part on a geographic location of the device; and
generate augmented live content by merging the extracted object with scenic digital content and with the at least one enhancement feature.

18. The device of claim 17, further comprising multiple imagers operational together to capture the scenic digital content with a rear facing camera, and capture the user digital content with a front facing camera, the user digital content including the object for extraction.

19. The device of claim 17, wherein the imaging manager is implemented as an artificial intelligence algorithm to generate the augmented live content from the extracted object, the scenic digital content, and the at least one enhancement feature.

20. The device of claim 17, wherein the imaging manager is implemented to determine stored scenic content as at least one of a still image, digital video, or a GIF usable with the augmented live content.
